(19) United States
(12) Patent Application Publication
(10) Pub. No.: US 2019/0030964 A1
(43) Pub. Date: Jan. 31, 2019

(54) ELECTRICALLY CONDUCTIVE MOLD RELEASE FOR NON-PNEUMATIC TIRES

(71) Applicant: Brian Narowski, Greenville, SC (US)

(72) Inventor: Brian Narowski, Greenville, SC (US)

(73) Assignee: COMPAGNIE GENERALE DES ETABLISSEMENTS MICHELIN, CLERMONT-FERRAND (FR)

(21) Appl. No.: 16/073,768

(22) PCT Filed: Jan. 29, 2016
(86) PCT No.: PCT/US2016/015649

§ 371 Date: Jul. 27, 2018

(51) Int. Cl. B60C 19/08; B60C 7/18; B29D 30/02; B29C 33/64; B60C 1/00; C08K 3/04; C08J 3/20

(52) U.S. Cl. CPC B60C 19/08; B60C 7/18; B29D 30/02; B60C 2007/146; B60C 1/00; C08K 3/04; C08J 3/20; B29C 33/64

(57) ABSTRACT

Embodiments of the present invention include non-pneumatic tires (100) having an electrically conductive path, and methods for forming the same. It is appreciated electrical charges may be generated during land vehicle operation and land vehicles are often grounded by providing an electrically conductive path between the vehicle and the ground. In embodiments of the present invention, a non-pneumatic tire (100) and a method for forming a non-pneumatic tire are described for providing an electrically conductive path between the vehicle and the ground at the non-pneumatic tire. The method for forming the non-pneumatic tire comprises the step of applying a mold release (290) to one or more molding surfaces (280) of the spoke mold wherein the mold release (290) includes an electrically conductive additive.

### BACKGROUND OF THE INVENTION

### Field of the Invention

This invention relates generally to non-pneumatic tires, and more particularly, to molding spokes of a non-pneumatic tire.

### Description of the Related Art

An emerging field in tire development involves the manufacture and use of non-pneumatic or hybrid tires that do not depend solely on pressurized gas to support the tire structurally. As a result, these non-pneumatic tires are not prone to deflation, which otherwise can render a pneumatic tire inoperable. Exemplary non-pneumatic tires are described in U.S. Pat. No. 7,201,194 (also referred to herein as the '194 Patent), the contents of which are herein incorporated by reference.

In one example, a non-pneumatic tire includes a tread that is attached to the outward extent of a plurality of spokes, the spokes being spaced apart around a rotational axis of the tire and each of the spokes extending lengthwise in a radial direction from a hub at an inward extent. The spokes are operably connected to each of the tread and hub by any means known in the art. For example, in certain embodiments, the spokes are molded with the hub and a shear band is employed to connect the tread to the spokes. Spokes are formed by pouring a molding material, such as a thermosetting material, into a spoke mold where the thermosetting material is cured or hardened. As described by the Abstract and col. 2, lines 28-41 of the '194 Patent, the plurality of spokes support the tire with the ability to deflect or flex. This deflecting or flexing helps the non-pneumatic tire simulate a pneumatic tire.

To prevent build-up of electrical charges that may be generated during land vehicle operation, land vehicles are often grounded by providing an electrically conductive path between the vehicle and the ground. Because non-pneumatic tires with spokes constructed of non electrically-conductive thermosetting materials do not have an electrically conductive path from the tread to the hub, grounding straps are independently attached to the vehicle, separate from the non-pneumatic tire, for the purpose of providing an electrically-conductive path between the vehicle and the ground. Accordingly, to eliminate the need for grounding straps, there is a need to provide an electrically conductive path in non-pneumatic tires.

### SUMMARY OF THE INVENTION

Embodiments of the present invention include non-pneumatic tires having an electrically conductive path, and methods for forming the same.

Particular embodiments of the present invention include a method for forming a non-pneumatic tire. One step of the method includes providing a spoke mold configured to form one or more spokes of a non-pneumatic tire. The spoke mold may include a mold cavity at least partially defined by one or more molding surfaces. An additional step includes applying a mold release to the one or more molding surfaces wherein the mold release includes an electrically conductive additive. In another step, a thermosetting material is arranged into the molding cavity. The thermosetting material is cured in the mold cavity to form one or more molded spokes of a non-pneumatic tire. The electrically conductive additive of the mold release is embedded within a thickness of each of the one or more molded spokes. The one or more molded spokes may then be removed from the mold.

Additional embodiments of the present invention include a non-pneumatic tire. The non-pneumatic tire includes one or more spokes formed of at least a cured thermosetting material wherein the cured thermosetting material includes an electrically conductive additive. In some embodiments, the electrically conductive additive is arranged within a thickness of at least one of the one or more molded spokes.

The foregoing and other embodiments, objects, features, and advantages of the invention will be apparent from the following more detailed descriptions of particular embodiments of the invention, as illustrated in the accompanying drawings wherein like reference numbers represent like parts of the invention.

### DETAILED DESCRIPTION OF THE DRAWINGS

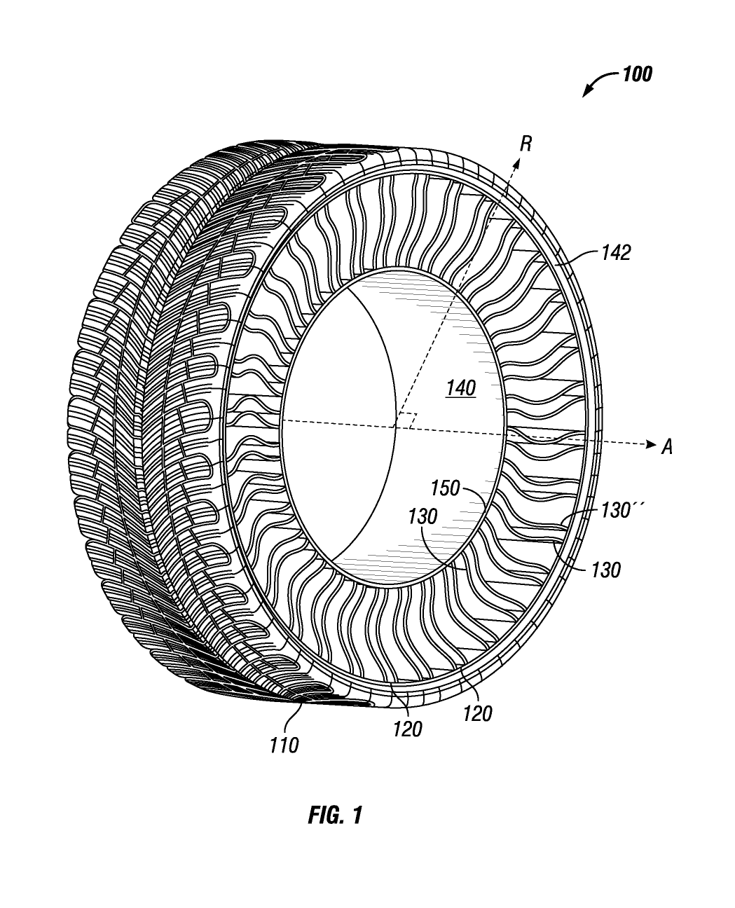

FIG. 1 is a perspective view of a non-pneumatic tire with molded spokes, according to an embodiment of the present invention.

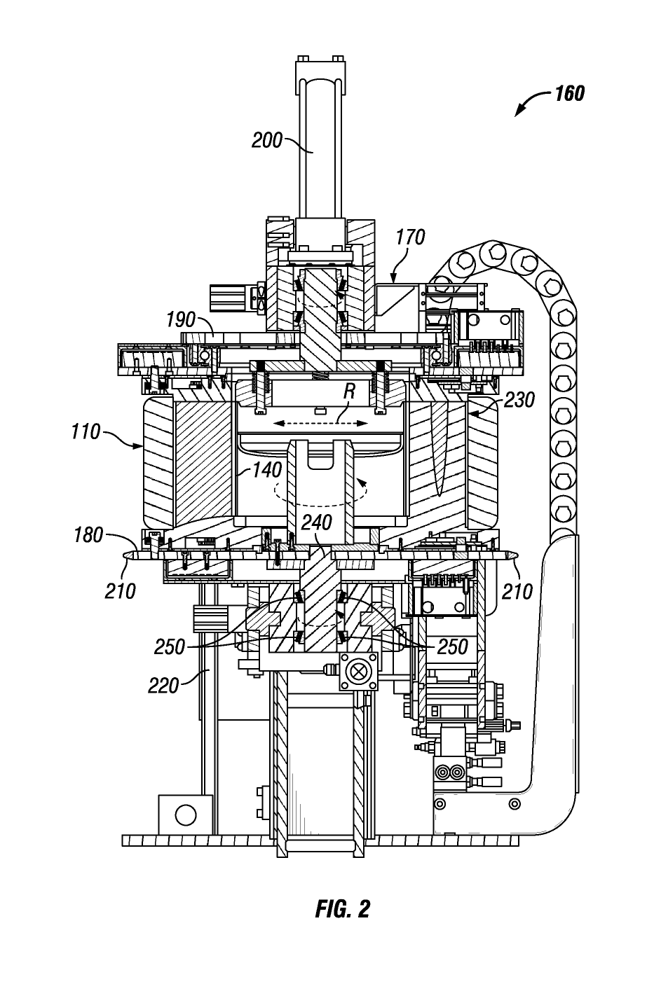

FIG. 2 is a side sectional view of a molding apparatus comprising a mold for forming the spokes of a non-pneumatic tire, according to an embodiment of the present invention.

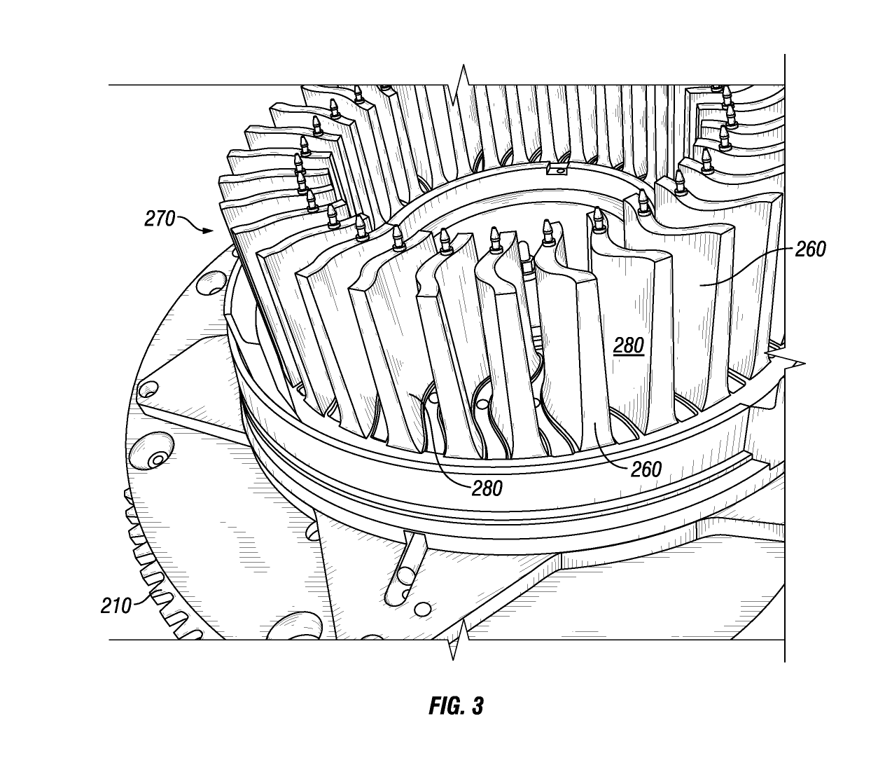

FIG. 3 is a perspective view of a bottom mold member of the mold shown in FIG. 2, according to an embodiment of the present invention.

FIG. 4 is a perspective view of the bottom mold portion shown in FIG. 3 being coated with a mold release that includes an electrically conductive additive, according to an embodiment of the present invention.

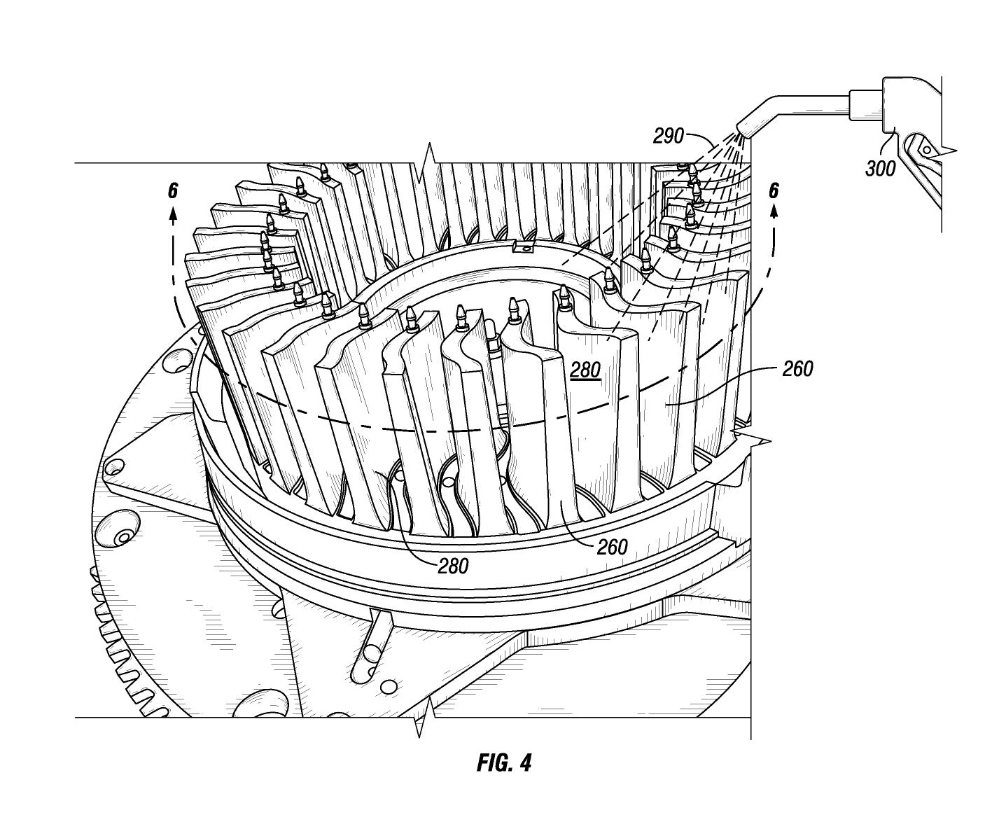

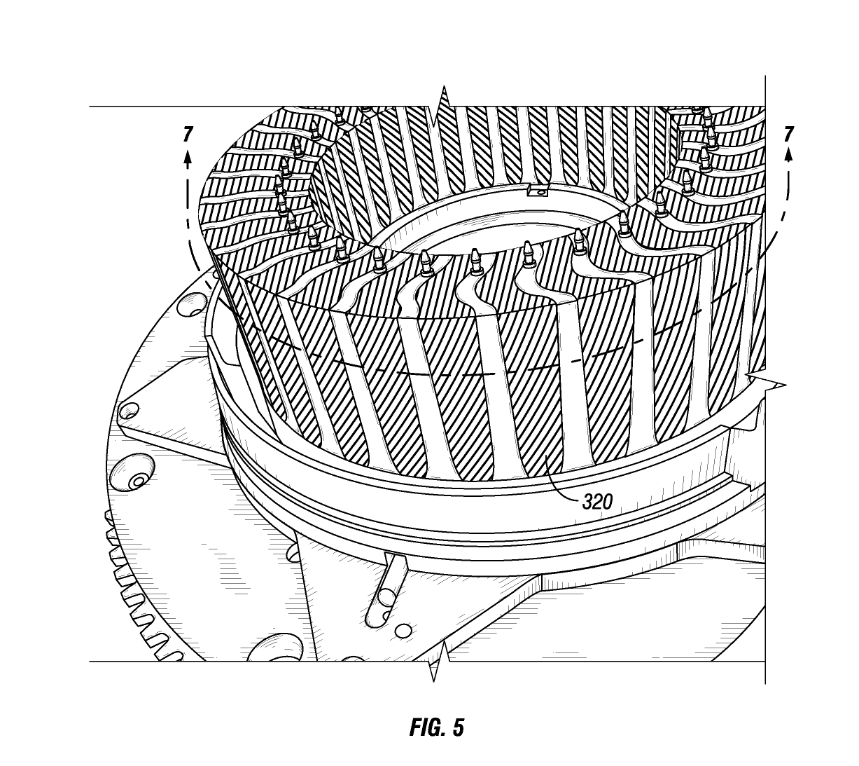

FIG. 5 is a perspective view of the coated bottom mold portion shown in FIG. 4, wherein molding material is arranged within the molding cavity in the bottom mold portion to form spokes with an electrically conductive additive embedded within a thickness of each spoke, according to an embodiment of the present invention.

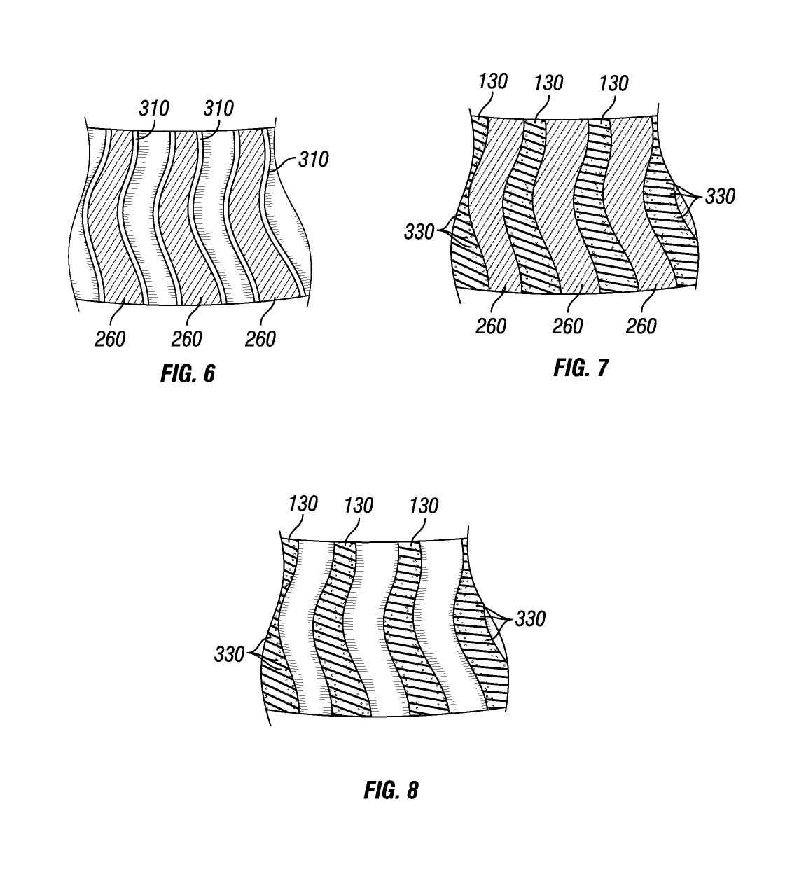

FIG. 6 is a partial sectional view of the coated bottom mold member of FIG. 4 taken along line 6-6.

FIG. 7 is a partial sectional view of molded spokes arranged within the bottom mold member as shown in FIG. 5 taken along line 7-7.

FIG. 8 is a partial sectional view of the molded spokes after having been demolded from the mold and containing electrically conductive additives embedded in the thickness of each spoke, according to an embodiment of the present invention.

### DETAILED DESCRIPTION OF PARTICULAR EMBODIMENTS

The present invention includes methods for molding spokes for a non-pneumatic tire and methods of forming a non-pneumatic tire where one or more spokes of the non-pneumatic tire include electrically conductive materials that were applied in mold release to a mold used to form the one or more spokes. The electrically conductive material may be arranged along an outer (that is, external) surface of each such spoke and/or embedded within a thickness of each such one or more spokes. It is beneficial to arrange the electrically conductive material within the thickness of a spoke, as electrically conductive materials arranged on an outer surface is susceptible to being worn or washed off, or otherwise more easily removed.

In particular embodiments, a non-pneumatic tire comprises a tread for engaging a ground surface and a hub for operably attaching the tire to a land vehicle. Extending in a radial direction between the tread and the hub are a plurality of spokes, each of which form an elongate member. The plurality of spokes are spaced apart around a rotational axis of the hub or more generally of the tire, where that the length of the elongate member extends in the radial direction of the hub or tire. In certain instances, the one or more spokes are configured to deflect during tire operation to provide desired tire performance characteristics. The tread is operably attached to a radially outward extent of the one or more spokes, which are in turn, connected at a radially inward extent to the hub. The hub, which generally forms a ring, is then operably connected to a land vehicle to configure the non-pneumatic tire for use. Attachment of the one or more spokes to the tread and hub may each be achieved by way of any means known in the art. For example, attachment may be achieved by molding the one or more spokes to the hub, which generally forms a ring and which is prepared for suitable bonding to the thermosetting material. In other examples, attachment is achieved using an adhesive and/or mechanical fasteners. In certain embodiments, an outer annular band is located between the radially outward extent of the spokes and the tread, where the spokes are operably attached to the outer annular band. In certain variations, an inner annular band is also arranged at a radially inner extent of the spokes, the spokes being operably attached to the inner band. This inner annular band is then used to attach the tire to a hub. The outer and inner annular bands may be formed separate from the spokes or molded with the spokes by pouring a molding material, such as thermosetting material, for example, into a spoke mold, where the thermosetting material is distributed within the spoke mold and then cured or hardened. The non-pneumatic tire described is by way of example, as other non-pneumatic tires known in the art may be formed using the methods described herein.

As noted above, particular embodiments of the present invention provide a method for forming a non-pneumatic tire having an electrically conductive path. Particular embodiments of such methods include providing a spoke mold configured to form one or more spokes of a non-pneumatic tire. The spoke mold includes a molding cavity at least partially defined by one or more molding surfaces. The molding cavity is formed by two or more separable structures referred to as molding members. Accordingly, the spoke mold comprises a plurality (two or more) separable molding members that form one or more spoke molding cavities. For example, in certain embodiments, a spoke mold includes a first mold half (a first mold member) and a second mold half (a second mold member), which separately or together include or form one or more elongate molding members spaced apart at least in a circumferential direction to form a molding cavity (a spoke molding cavity). Each of the elongate molding members are also referred to herein as a core. Between each of the spaced apart cores are voids forming a portion of the molding cavity and configured to form a spoke upon arranging the first mold half and the second mold half in a mold-closed arrangement. Furthermore, although the embodiments discussed herein focus on molding spokes for the non-pneumatic tire, the present invention is also applicable to forming other portions of a non-pneumatic tire, such as the hub, tread, and a band (referred to herein also as a shear band) for use in connecting the tread to the spokes, for example.

Because each molded spoke is prone to adhering to any molding surface of the molding cavity, a mold release is applied to the molding surfaces of the molding cavity to improve demolding of each molded spoke. Otherwise, the spokes may become distorted or damaged, resulting in an undesirable and non-uniform appearance. Therefore, the methods described above include applying a mold release to the one or more molding surfaces of the molding cavity. A mold release may be of any composition known in the art such that a film is formed on the surface of the one or more molding surfaces. In one particular embodiment, the mold release is silicon-based. The mold release may be applied to the one or more molding surfaces using any known technique(s), such as spraying, brushing, injecting, submerging, and atomizing, for example.

The mold release applied to the molding cavity and one or more molding surfaces therein includes an electrically conductive additive. Moreover, it is appreciated that one or more electrically conductive additives may be added. The electrically conductive additives may form any known electrically conductive material that facilitates the flow of a current through material by means of electrical conductivity. An example of an electrically conductive additive includes carbon black.

After the mold release is applied to one or more molding surfaces defining the molding cavity, a thermosetting material is arranged within the molding cavity. The thermosetting material is arranged in the molding cavity to form the spokes of a non-pneumatic tire, and upon being deposited in the molding cavity, and/or during curing, the mold release and the electrically conductive additives are intermixed with the thermosetting material. It is appreciated that the thermosetting material may comprise any desired thermosetting material. An example of a thermosetting material includes polyurethane. In addition, a combination of thermosetting materials may be used that is suitably durable and strong to support the loads applied to the tire. The thermosetting material may be added to the spoke mold by using any known process(es) and/or mechanism(s) known in the art, which includes pouring and injecting. By further example, the thermosetting material may be added through one or more pouring slots extending into the one or more cavities. The one or more pouring slots may be provided at any location on the perimeter of the spoke mold. By further example, one or more pouring slots may be provided at an upper platen, a lower platen, a mold ring, and/or a mold cap. The one or more pouring slots may then be sealed during curing after the thermosetting material has been added.

Such methods further include curing the thermosetting material within the mold cavity to form one or more molded spokes of a non-pneumatic tire. The step of curing may be achieved using any known process(es) and/or mechanism(s). For example, in certain instances, heat is supplied to the mold and transferred to the thermosetting material, such that the thermosetting material cures at a desired rate. In certain embodiments, centrifugation is performed (that is, the mold is spun) to cause the thermosetting material to move or migrate to fill the cavities configured to form each of the one or more spokes and/or to remove air bubbles entrapped during pouring.

As a result of curing the thermosetting material within the spoke mold, the electrically conductive additive from the mold release is embedded within a thickness of at least one of the one or more molded spokes. The thickness of each molded spoke is defined by the molding cavity. The embedded electrically conductive additive is positioned inward from any outer (external) surface of a corresponding spoke formed by a molding surface of the mold. Accordingly, the electrically conductive additive is embedded within a thickness of the thermosetting material. By embedding the electrically conductive additive into the thermosetting material of a spoke, the electrically conductive additive will not affect the bulk properties of the molded spoke . Additionally, the electrically conductive additive may also be affixed to an outer (exterior) surface of a molded spoke. In these various embodiments, the electrically conductive additives provide an electrically conductive path along the length of a spoke, so to create an electrically conductive path extending between the tread and hub of a non-pneumatic tire. This eliminates the need for the use of grounding straps or reduces the number of straps required for a vehicle. After demolding the one or more spokes, the non-pneumatic tire is fully assembled. In particular embodiments, the electrical resistivity of the non-pneumatic tire is at a value less than 1 Giga-ohms. In alternative embodiments, in lieu of or in addition to using the mold release, the electrically conductive additive may be added to the thermosetting material prior to being inserted into the mold or molding cavity. This addition may be achieved during formation of the thermosetting material or thereafter. Also, in addition to, or in lieu of, the methods described above, the electrically conductive additive may be applied directly to an outer surface of a molded spoke of the non-pneumatic tire.

Once the thermosetting material is cured, the one or more spokes of the non-pneumatic tire are removed (demolded) from the spoke mold. Removal may be achieved using any process(es) and/or mechanism(s) known in the art

Particular embodiments of the methods discussed above will now be described in further detail below in association with the figures filed herewith exemplifying the performance of the methods in association with particular embodiments.

With reference to FIG. 1, a non-pneumatic tire is illustrated with an orientation relative a radial direction R and an axial direction A. The tire 100 comprises a tread 110 that is operably connected to a radially outward extent 120 of spokes 130, which in turn, are connected to a hub 140, which is annular, at a radially inward extent 150 of the spokes 130. The tread and hub are each connected to the spokes by means known in the art, such as by molding to the hub 140, which have been prepared for suitable bonding to the thermosetting material. For the version of the tire 100 shown, spokes 130 are formed of molded thermosetting material. It can also be seen that in the embodiment shown, spokes 130 are spaced apart in a circumferential direction of the tire, and are optionally grouped in pairs of spokes 130, 130″. The spacing within each pair and the spacing between each adjacent pair may or may not be consistent or the same around the tire. Spokes 130 support the tire 100 in tension near the top of the tire 100 and not in compression. Instead, the spokes 130 at the bottom of the tire near the contact patch, which is where the tread 110 of the tire 100 contacts the road, compress or buckle easily. This helps the tire to simulate the pneumatic support function of a pneumatic tire. An outer band, or shear band, 142 is provided to connect the radially outer extent of the spokes 130 to the tire tread 110.

Referring now to an exemplary embodiment in FIG. 2, a molding apparatus 160 is shown for at least forming the spokes 130 of FIG. 1. The molding apparatus 160 includes a vertical mold press 170 comprising a lower platen 180, upper platen 190, hydraulic cylinder 200, gear 210 and frame 220. The frame 220 is fixed and the lower platen 180 is translatably fixed in a horizontal plane but is free to translate vertically while the upper platen 190 is pivotally connected to the frame 220 via a pin. The upper platen 190 is moved by the hydraulic cylinder 200 in and out of a parallel alignment with the lower platen 180. The gear 210 mates with a drive pinion (not shown) powered by a motor (not shown) that can engage or disengage the gear 210 when it is appropriate to rotate the lower platen 180 and mold 230, which is affixed thereto, to form the spokes 130. It is contemplated that the upper platen 190 could be translatably connected to the frame 220 and could be moved by means other than hydraulic, such as pneumatic, mechanical or other means commonly known in the art. Likewise, the rotation of the lower platen 180 could be achieved by way of other means known in the art such as by an electric motor that is directly coupled to the shaft 240 to which the lower platen 180 is attached. The translation of the lower platen can be achieved using the same methods mentioned previously for moving the upper platen 190. Roller bearings 250 are also provided to guide the rotation of the lower platen 180 and to minimize the friction associated with its rotation.

The mold apparatus may be used in the following manner to create the spokes of the tire. First, an outer ring or cap of the mold is removed so to access the inner cavity of the mold. The mold may receive the inward extent 150 of the spokes (i.e., hub or wheel of the tire) and the outward extent 120 of the spokes (i.e., the outer annular portion of the tire, a tread receiving portion, a tread, etc.). Mold cores (as depicted in FIG. 3), which are elongate molding members, at least partially define cavities configured to form the spokes within the molding cavity, and by doing so, extend between the outward extent 120 of the spokes and the inward extent 150 of the spokes. Caps may be used to secure the thermosetting material (as depicted in FIG. 5) within the mold. The mold may be rotated as the thermosetting material is poured into the mold by a nozzle (not shown) through a pouring slot (not shown). The pouring slot is open to the molding cavity (as depicted in FIG. 3). The rotation of the mold, or centrifugation, causes the thermosetting material to fill the molding cavity, or the spoke region, and heat is supplied to the mold and transferred to the thermosetting material. The heat helps the thermosetting material to harden and cure by keeping it warm. The thermosetting material forming the spokes may extend from the hub or wheel of the tire to the tread of the tire, allowing the spokes to bond to the hub or wheel and tread during the curing process.

Turning to FIG. 3, the exemplary mold comprises two mold halves 270, a second mold half and a first mold half (one of which is illustrated by FIG. 3). In using the term halves, the meaning does not necessarily connote equal halves, although it is possible that the halves can be equal halves. Arranged within one or both mold halves are mold cores 260, which are elongate molding members, for use in forming cavities for molding the spokes. One or both of the inner and outer annular bands of the tire may optionally be molded with the spokes in the mold. Mold cores 260 found on a bottom of mold half 270 are shown and form the spokes and inside surfaces of the annular bands. The molding surfaces 280 of the mold core form the spokes themselves. The mold cores coming from the lower mold half interarticulate with similarly configured mold cores coming from the upper mold half so that the thickness of the spokes remain constant. These mold cores may have additional surfaces for forming the inside surfaces of the annular bands.

FIG. 4 illustrates the mold cores 260 wherein a mold release 290 is applied to the mold cores 260 and molding surfaces 280. In this embodiment, the mold release 290 is sprayed on the mold cores 260, including the molding surfaces 280, using a spray nozzle 300. Once applied, the mold release 290 forms a film on the molding surfaces 280 of the mold cores 260. In the present invention, the mold release 290 comprises an electrically conductive additive which is included within the film formed on the molding surfaces 280 of the mold cores 260. FIG. 6 is a sectional view of the spoke mold with the mold release 290 forming a film 310 on the molding surfaces 280 of the mold cores 260.

Turning to FIG. 5, a thermosetting material 320 is added to the spoke mold and fills the voids or cavities between each mold core 260. As indicated above, for the version of the tire 100 illustrated in FIG. 1, the spoke region comprising the spokes 130 are formed by pouring a thermosetting material into a rotational mold where the thermosetting material is spread via centrifugation and then cured or hardened. The thermosetting material is cured within the spoke mold to form the molded spoke region of the non-pneumatic tire. Upon adding the thermosetting material to the spoke mold, the mold release 290, comprising the electrically conductive additive, mixes with the thermosetting material. This mixing may occur immediately, upon implementation of the centrifugal action before or during curing, or during curing, or any combination thereof. Once cured, the electrically conductive additive is embedded in the thickness of the cured thermosetting material. This provides an electrically conductive path through the spoke region of the non-pneumatic tire. In other words, this provides an electrically conductive path from the tread to the hub.

FIG. 7 illustrates a sectional view of the spoke mold with the spokes 130 formed between mold cores 260. The electrically conductive additive 330 is illustrated as embedded within the thermosetting material forming the spokes 130. Turning to FIG. 8, a sectional view of a spoke region is further illustrated after removal from the spoke mold. Again, the electrically conductive additives 330 is illustrated as embedded within the thickness of the spokes 130.

The terms “comprising,” “including,” and “having,” as used in the claims and specifications herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the invention.

While this invention has been described with reference to particular embodiments thereof, it shall be understood that such description is by way of illustration only and should not be construed as limiting the scope of the claimed invention. Accordingly, the scope and content of the invention are to be defined only by the terms of the following claims. Furthermore, it is understood that the features of any specific embodiment discussed herein may be combined with one or more features of any one or more embodiments unless otherwise noted.

What is claimed is:

1. A method for forming a non-pneumatic tire comprising:
providing a spoke mold configured to form one or more spokes of a non-pneumatic tire, the spoke mold including a mold cavity at least partially defined by one or more molding surfaces;
applying a mold release to the one or more molding surfaces, the mold release including an electrically conductive additive;
arranging a thermosetting material into the molding cavity;
curing the thermosetting material within the mold cavity to form one or more molded spokes of the non-pneumatic tire, such that the electrically conductive additive of the mold release is embedded within a thickness of each of the one or more molded spokes; and, removing the one or more molded spokes from the mold.

2. The method of claim 1, wherein the electrically conductive additive is also affixed to an outer surface of the thermosetting material of the one or more molded spokes.

3. The method of claim 1, wherein the mold release is silicon-based.

4. The method of claim 1, wherein the mold release is applied by at least one of spraying, brushing, injecting, submerging, or atomizing.

5. The method of claim 1, wherein the thermosetting material is polyurethane.

6. The method of claim 1, where the one or more molded spokes are characterized as having an electrical resistivity equal to or less than 1 Giga-ohms.

7. A non-pneumatic tire comprising:
one or more molded spokes formed of at least a cured thermosetting material, the cured thermosetting material including an electrically conductive additive, where the electrically conductive additive is arranged within a thickness of at least one of the one or more molded spokes.

8. The non-pneumatic tire of claim 7, wherein the thermosetting material is polyurethane.

9. The non-pneumatic tire of claim 7, wherein the electrically conductive additive is also affixed to an outer surface of the thermosetting material of the one or more molded spokes.

10. The non-pneumatic tire of claim 7, where the electrically conductive additive is embedded in the molded thermosetting material and is characterized as having an electrical resistivity equal to or less than 1 Giga-ohms.
